(19) United States
(12) Patent Application Publication
(10) Pub. No.: US 2003/0209043 A1
(43) Pub. Date: Nov. 13, 2003

(54) Electronically-driven lock

(76) Inventors: Tsun-Tsai Yeh, Tu-Chen (TW); Tso-Tung Yu, Hsinchu (TW)

Correspondence Address: WEI TE CHUNG, FOXCONN INTERNATIONAL, INC., 1650 MEMOREX DRIVE, SANTA CLARA, CA, 95050, US

(21) Appl. No.: 10/330,930

(22) Filed: Dec. 26, 2002

(30) Foreign Application Priority Data
May 9, 2002 (TW) 91206529

(51) Int. Cl. E05B 47/00

(52) U.S. Cl. 70/280

(57) ABSTRACT

An electronically-driven lock (1) includes an inner lock unit (2), an outer lock unit (5), a bolt assembly (3) having a latch, and a transmission shaft (4) extending through the bolt assembly to actuate the latch. The inner lock unit includes a base (80), a driving unit (60), a clutch (50), a knob (30), and a top cover (20) covering the base. The driving unit includes a gear plate (64). The gear plate includes a pair of driving protrusions (641). The knob has a mating shaft (32) fittingly receiving the transmission shaft therein. The clutch includes a pair of driven protrusions (541), and defines a generally rectangular mating slot (52) fittingly receiving the mating shaft therethrough. The driving protrusions engage the driven protrusions to rotate the clutch. The clutch accordingly rotates the mating shaft of the knob to rotate the transmission shaft. Thus the latch can be actuated to locked position or unlocked.

### BACKGROUND OF THE INVENTION

1. Field of the Invention

The present invention relates to a door lock, and more particularly to an electronically-driven lock that incorporates an electrically operated driving mechanism to control locking and unlocking of the electronically-driven lock. The application relates to a contemporaneously filed application having the title of “ELECTRICALLY OPERATED LOCK” while with the same inventors and the same assignee with the invention.

2. Description of Related Art

To secure a door, a bolt may be extended from the door into a suitable opening in the door jamb. The bolt may be interconnected with a bolt assembly in a conventional lock which is operated with a knob or a handle lever. The bolt is operated to extract or extend when the latch actuated by a key is in unlocked state. Turning the key in the lock will either lock or unlock a latch of a bolt assembly of the lock. However, it is inconvenient for a user to have to carry the key on his or her person. In addition, the user's hands may not be free, particularly at night. Furthermore, particularly at night, it can be difficult to insert the key into the lock. Electronically driven locks can overcome these problems. However, the transmission and driving devices of conventional electronically driven locks are complicated, and require numerous components. This inflates the cost of materials and assembly. Moreover, the motor of an electronically driven lock may fail. When this happens, considerable physical effort is required to turn a key manually to operate the latch of the bolt assembly of the lock, because the transmission device and motor must be “back driven” during such operation.

An electronically driving lock that overcomes the above-described disadvantages of conventional locks is desired.

### SUMMARY OF THE INVENTION

Accordingly, an object of the present invention is to provide an electronically-driven lock having a simple transmission device which allows easy manufacturing and assembly, and which reduces costs.

Another object of the present invention is to provide an electronically-driven lock that also allows easy manual operation of the lock.

To achieve the above objects, an electronically-driven lock in accordance with the present invention comprises an inner lock unit, an outer lock unit, a bolt assembly, and a transmission shaft. The lock units are attached to opposite side of a door. The bolt assembly has a latch therein, and is mounted in the door. The transmission shaft extends through a cross slot of the bolt assembly to actuate the latch. The inner lock unit comprises a base, a driving unit, a clutch, a knob, and a top cover covering the base. The driving unit comprises a gear plate. The gear plate comprises a pair of driving protrusions. The knob has a mating shaft fittingly receiving the transmission shaft therein. The clutch comprises a pair of driven protrusions, and defines a generally rectangular mating slot fittingly receiving the mating shaft therethrough. The driving protrusions of the gear plate engage the driven protrusions of the clutch to rotate the clutch. The clutch accordingly rotates the mating shaft of the knob to rotate the transmission shaft. Thus the latch can be actuated between a locked state and an unlocked state.

Other objects, advantages and novel features of the present invention will be drawn from the following detailed description of a preferred embodiment of the present invention with attached drawings, in which:

### BRIEF DESCRIPTION OF THE DRAWINGS

FIG. 1 is an exploded isometric view of an electronically-driven lock in accordance with the present invention;

FIG. 2 is an exploded isometric view of an inner lock unit of the lock of FIG. 1;

FIG. 3 is an isometric view of a base of the inner lock unit of FIG. 2;

FIG. 4 is an enlarged assembled view of FIG. 2, but not showing a top cover and one connector thereof;

FIG. 5 is a top plan view of FIG. 4, showing the lock is in a locked position;

FIG. 6 is similar to FIG. 5, but the lock is in an unlocked position and

FIG. 7 is an enlarged substantially assembled view of FIG. 2, but viewed from another aspect.

### DETAILED DESCRIPTION OF THE INVENTION

Reference will now be made to the drawing figures to describe the present invention in detail.

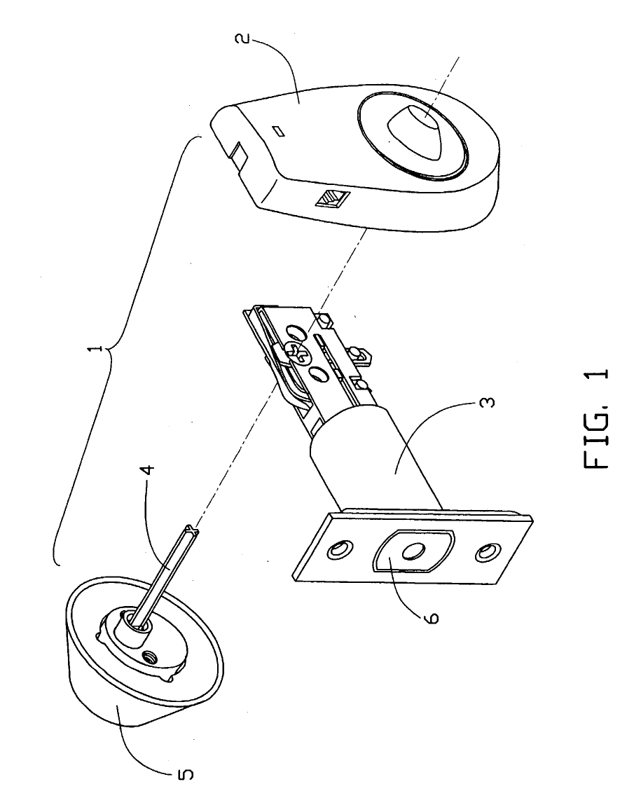

Referring to FIG. 1, an electronically-driven lock 1 in accordance with a preferred embodiment of the present invention comprises an inner lock unit 2, a bolt assembly 3, an outer lock unit 5, and a transmission shaft 4 having a cross-shaped cross section. The inner and outer lock units 3, 5 are attached to respective opposite sides of a door. The bolt assembly 3 has a latch (not shown) and a bolt 6, and is mounted in the door. The transmission shaft 4 fittingly extends through a cross slot (not labeled) of the bolt assembly 3 to actuate the latch. The latch is actuated between a locked state and an unlock state by rotation of the transmission shaft 4.

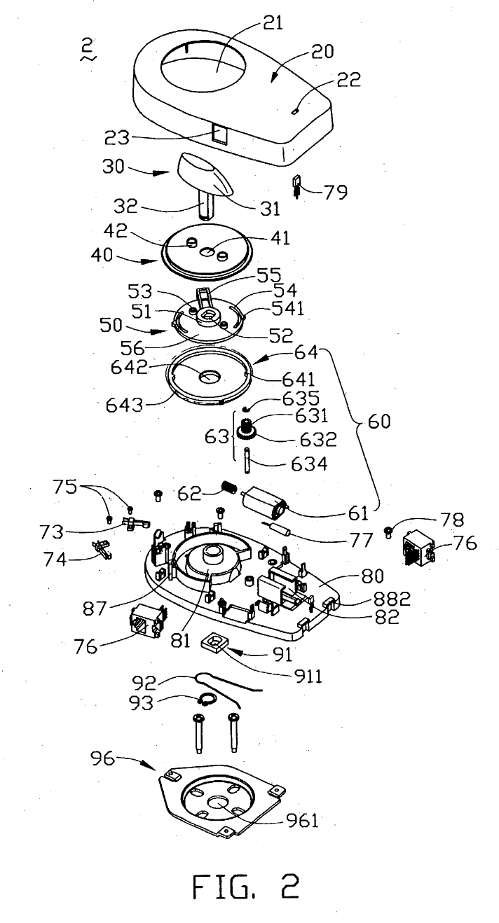

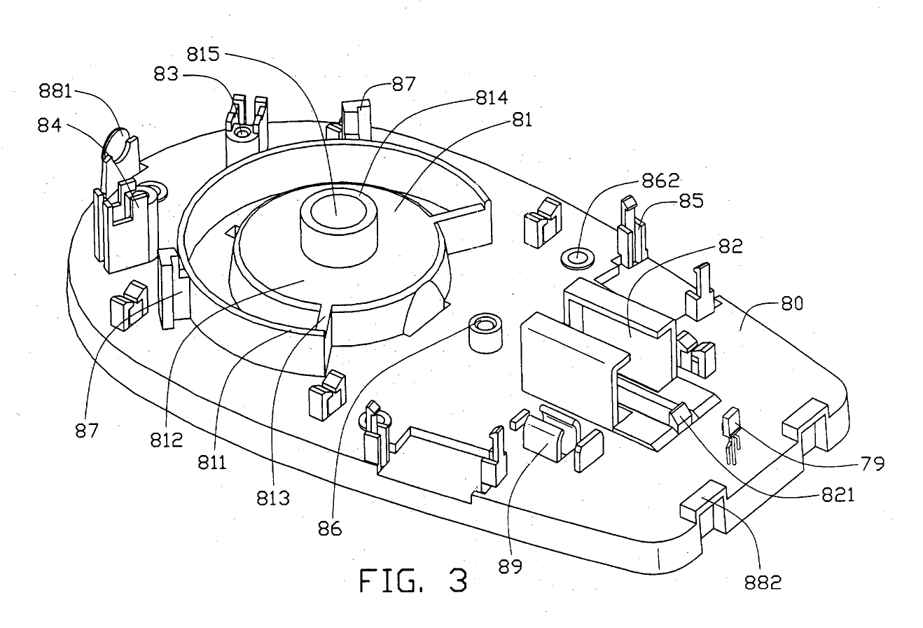

Referring to FIGS. 2 and 3, the inner lock unit 2 comprises a base 80, a driving unit 60, a clutch 50, a knob 30, and a top cover 20 covering the base 80.

The top cover 20 defines a main hole 21 at one side of a top wall thereof, and an aperture 22 in an opposite side of the top wall. The main hole 21 is for extension of the knob 30 therethrough, and the aperture 22 is for fittingly fixing an indicator 79 therein. A pair of connector ports 23 (only one visible) is respectively defined in opposite sidewalls of the top cover 20.

The knob 30 comprises a head 31, and a mating shaft 32 integrally depending from a middle of the head 31. The mating shaft 32 has a generally rectangular cross-section. A cross-slot (not visible) is defined in a bottom surface of the mating shaft 32, for fitting extension of the transmission shaft 4 thereinto.

The clutch 50 comprises a base 56, and a central sleeve 51 extending upwardly from the base 56. A generally rectangular mating slot 52 is defined through the central sleeve 51, corresponding to the mating shaft 32 of the knob 30. A pair of arcuate slits (not labeled) is defined in opposite sides of the base 56 respectively, thereby forming a corresponding pair of resilient arcuate portions 54. A driven protrusion 541 is outwardly formed from a middle section of each resilient arcuate portion 54. A pair of posts 53 extends upwardly from the base 56 on opposite sides of the central sleeve 51 respectively. A sensor arm 55 extends radially outwardly from the central sleeve 51.

Preferred configurations of the transmission shaft 4, the bolt assembly 3, the mating shaft 32 of the knob 30 and the mating slot 52 of the clutch 50 have been shown and described. It will be readily appreciated that various other configurations of these components may be adopted. For example, the transmission shaft 4 may have a triangular star-shaped cross section, and the bolt assembly 3 may have a triangular star-shaped slot. Similarly, the mating shaft 32 may have a triangular cross section, and the mating slot 52 may be triangular.

A cap plate 40 is for covering the clutch 50, to protect components in the clutch 50 from dust and contamination. A through hole 41 is defined in a center of the cap 40, for extension of the mating shaft 32 of the knob 30 therethrough. A pair of hollow cylindrical seats 42 is formed on an upper surface of the cap 40 on respective opposite sides of the through hole 41, corresponding to the posts 53 of the clutch 50.

The driving unit 60 comprises a motor 61, a worm 62, a gear set 63, and a gear plate 64. The gear set 63 comprises an upper gear 631, a lower gear 632 integrally formed with the upper gear 631, a gear shaft 634, and a C-shaped gasket 635. The gear shaft 634 sequentially extends through the lower gear 632, the upper gear 631 and the C-shaped gasket 635.

The gear plate 64 is circular, and comprises a low-profile outer circumferential wall (not labeled). A pair of driving protrusions 641 is inwardly formed from respective opposite sides of an inner periphery of the circumferential wall of the gear plate 64. An annular gear portion 643 is formed on an outer periphery of the circumferential wall of the gear plate 64. A through hole 642 is defined in a center of the gear plate 64. A stop (not visible) depends from a bottom face of the gear plate 64.

The motor 61 connects with one end of the worm 62. An opposite end of the worm 62 meshes with the upper gear 631 of the gear set 63, and the lower gear 632 of the gear set 63 meshes with the annular gear portion 643 of the gear plate 64. The driving protrusions 641 of the gear plate 64 engage with the driven protrusions 521 of the clutch 50, to actuate the clutch 50 to rotate according to rotation of the gear plate 64. The mating shaft 32 of the knob 30 is received in the mating slot 52 of the clutch 50. When the clutch 50 rotates the mating shaft 32, the transmission shaft 4 rotates accordingly. The transmission shaft 4 thus actuates the latch of the bolt assembly 3 between a locked state and an unlocked state.

Two connectors 76 and a pair of sensor switches 73, 74 are received in the lock unit 2. The sensor switches 73, 74 can contact the sensor arm 55 of the clutch 50 when the sensor arm 55 is at two different positions respectively, thereby detecting a locked or unlocked status of the lock 1.

Referring also to FIG. 3, a supporting bracket 81 is formed on the base 80 for supporting the gear plate 64. The supporting bracket 81 comprises a high-profile circumferential wall 811, a low-profile table 812, a pair of tabs 813, a sleeve 814, and a through hole 815. The table 812 is at a middle of the supporting bracket 81. The sleeve 814 extends upwardly from a middle of the table 812. The through hole 815 is defined in the sleeve 814. The circumferential wall 811 has a substantially circular configuration, and surrounds most of the table 812. The tabs 813 connect between respective opposite ends of the circumferential wall 811 and respective proximal portions of the table 812. The tabs 813 are thus each oriented in respective radial directions from a center of the supporting bracket 81. A height of the tabs 813 is the same as a height of the table 812. The tabs 813 are for abutting the stop of the gear plate 64, to limit a range of rotation of the gear plate 64. A pair of spaced blocks 87 is formed on the base 80. The blocks 87 are each integrally joined with an outer circumferential face of the circumferential wall 811.

A motor housing 82 is formed on the base 80 generally opposite the supporting bracket 81, for receiving the motor 61. A resilient clip 821 is formed in the base 80 at the motor housing 82, for locating and securing the motor 61 in the motor housing 82. A detector housing 89 is formed on the base 80 next to the motor housing 82, for receiving a shock detector 77. A cylindrical seat 861 is formed on the base 80 generally between the supporting table 81 and the motor housing 82, for receiving the gear set 63. Two spaced switch holders 83, 84 extend upwardly from the base 80, near a periphery of the supporting table 81 that is distal from the motor housing 82. A pair of connector bracket assemblies 85 is formed at respective opposite longitudinal sides of the base 80 at opposite sides of the motor housing 82, for respectively receiving the two connectors 76. The connectors 76 are for connecting outside electrical circuitry (not shown) with an inside of the lock unit 2. A plurality of screw holes 862 is defined in peripheries of the base 80.

A pair of spaced retaining tabs 882 is upwardly formed from an end of the base 80 that is near the motor housing 82. A catch 881 is upwardly formed from an opposite end of the base 80 that is near the supporting bracket 81.

Referring particularly to FIG. 2, a bottom cover 96 is attached to a bottom surface of the base 80. A central hole 961 is defined in the bottom cover 96, for extension of the mating shaft 32 of the knob 30 therethrough. A plurality of spaced fixing apertures (not labeled) is defined in peripheries of the bottom cover 96. A positioning block 91, a spring clip 92, and a gasket 93 are for being sequentially placed around the mating shaft 32 of the knob 30. A through hole 911 is defined through the positioning block 91, for receiving the mating shaft 32. A plurality of bolts 78 is for extension through the fixing apertures of the bottom cover 96 to engage in the screw holes 862 of the base 80.

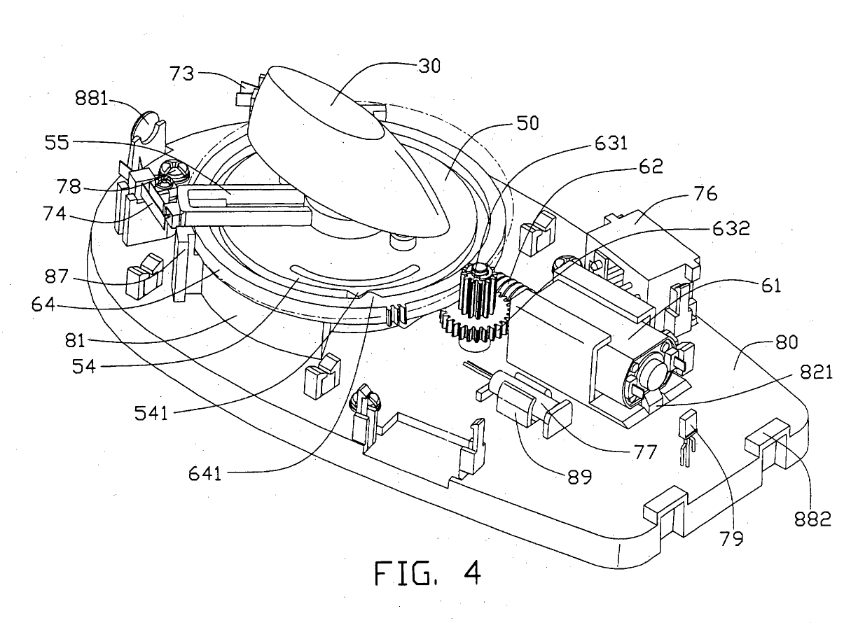

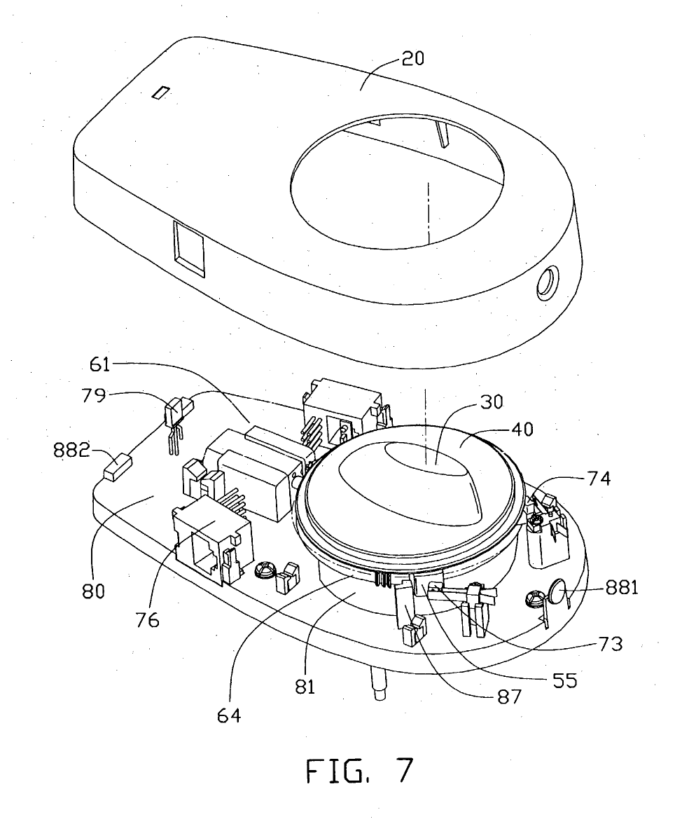

Referring also to FIGS. 4 and 7, the following is a description of progressive stages of assembly of the inner lock unit 2.

Step 1: The worm 62 is connected to the motor 61. The motor 61 is received in the motor housing 82. The resilient clip 821 facilitates retention of the motor 61 in the motor housing 82.

Step 2: One end of the gear shaft 634 is extended through the gear set 63 and the C-shaped gasket 635. The gear set 63 is movably fixed on the seat 861 of the base 80. The lower gear 632 meshes with the worm 62.

Step 3: The gear plate 64 is placed around the sleeve 814, and supported on the table 812. The stop (not visible) of the gear plate 64 has limited travel between the tabs 813 outside of the supporting bracket 81. The clutch 50 is rotatably received in the gear plate 64. The annular gear portion 643 meshes with the upper gear 631 of the gear set 63. The cap plate 40 is attached on the clutch 50, with the posts 53 of the clutch 50 being received in the hollow cylindrical seats 42 of the cap plate 40.

Step 4: The mating shaft 32 of the knob 30 is sequentially inserted through the through hole 41 of the cap plate 40, the mating slot 52 of the clutch 50, the through hole 642 of the gear plate 64, and the through hole 815 of the supporting bracket 81 until the mating shaft 32 finally extends out beyond a bottom of the base 80. The mating shaft 32 is fittingly received in the mating slot 52 of the clutch 50.

Step 5: The positioning block 91 is placed around the mating shaft 32 of the knob 30. The spring clip 92 and the gasket 93 are then sequentially placed around the mating shaft 32. The bolts 78 are extended through the fixing apertures of the bottom cover 96 to engage in the screw holes 862 of the base 80. The bottom cover 96 is thus fixedly attached to the bottom of the base 80.

Step 6: The connectors 76 are respectively mounted in the connector bracket assemblies 85. The sensor switches 73, 74 are respectively received in the switch holders 83, 84 of the base 80. Accordingly, the sensor arm 55 of the clutch 50 can rotate to contact each of the sensor switches 73, 74. Rotation of the sensor arm 55 is limited to a range between the switch holders 83, 84. The shock detector 77 is received in the detector housing 89.

Step 7: Finally, the base 80 and the top cover 20 are attached together. The retaining tabs 872 and the catch 871 of the base 80 engage with complementary locking mechanisms (not shown) of the top cover 20. The indicator 79 is secured in the aperture 22. The connector ports 23 of the top cover 20 coincide with the connectors 77 of the base 80. The cap plate 40 protrudes through the central hole 21 of the top cover 20. Thus, the inner lock unit 2 is fully assembled.

Referring to FIG. 4, in operation, the motor 61 rotates the lower gear 632 via the worm 62, the upper gear 631 actuates the gear plate 64 to rotate, and the gear plate 64 rotates at a speed lower than that of the motor 61. When the gear plate 64 rotates, the driving protrusions 641 of the gear plate 64 engage with the driven protrusions 521 of the clutch 50. The clutch 50 is thereby actuated to rotate clockwise or anti-clockwise.

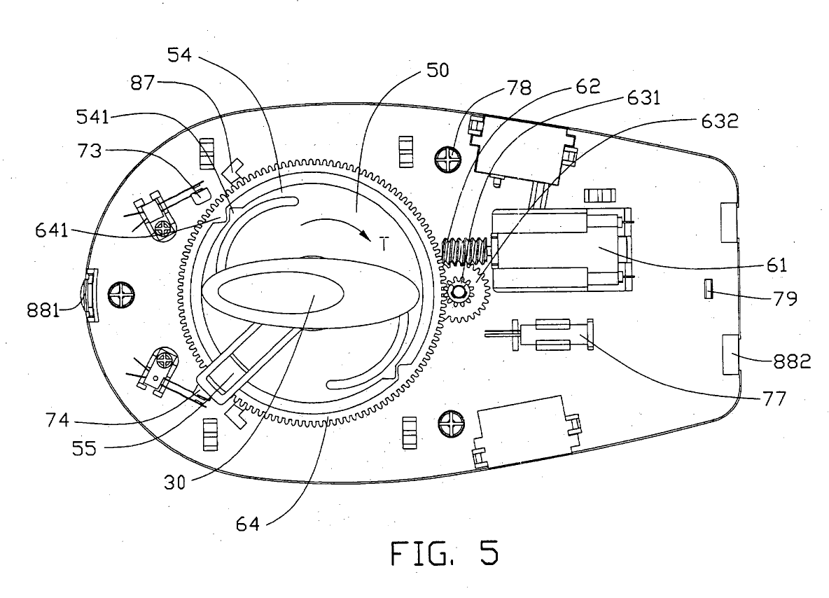

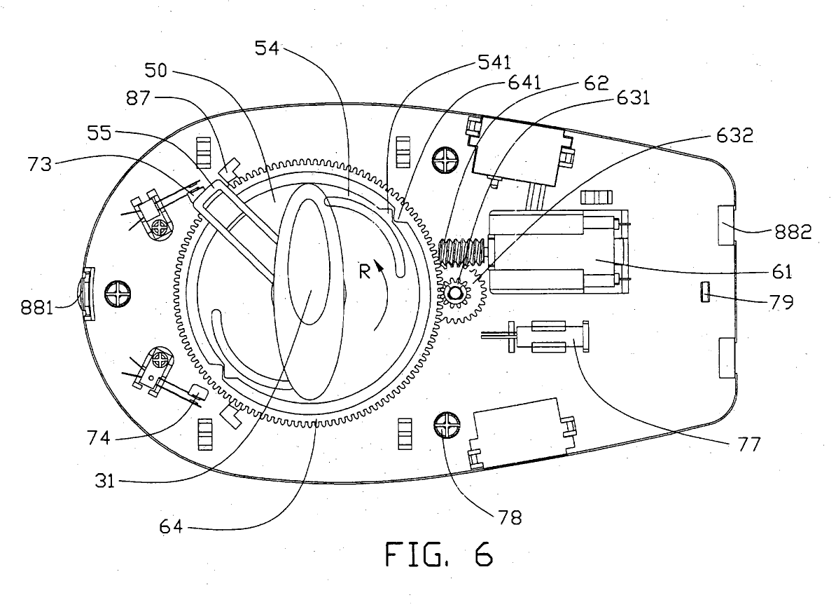

Referring to FIGS. 5 and 6, in a non-operational status, the sensor arm 55 of the clutch 50 is in contact with the sensor switch 74. When the motor 61 is turned on, the worm 62 drives the gear set 63 to rotate. The upper gear 631 of the gear set 63 rotates in an anti-clockwise direction R. The gear plate 64 is accordingly rotated in a clockwise direction T. The driving protrusions 641 of the gear plate 64 abut against the driven protrusions 541 of the clutch 50 at respective first side faces of the driven protrusions 521. The gear plate 64 actuates the clutch 50 to rotate in the clockwise direction T. Accordingly, the clutch 50 actuates the mating shaft 32 to rotate, and the transmission shaft 4 is rotated. The latch of the bolt assembly 3 is actuated to be locked. Simultaneously, referring to FIG. 6, the sensor arm 55 of the clutch 50 rotates to contact the sensor switch 73. The motor 61 is actuated by the sensor switch 73 to prepare to turn off. When the transmission shaft 4 reaches an unlocked position, the clutch 50 has been stopped, but the motor 61 continues to rotate due to delay control circuitry. Thus the gear plate 64 continues to rotate such that the driving protrusions 641 force the driven protrusions 521 and the resilient arcuate portions 54 to deform inwardly. The driving protrusions 641 ride over the driven protrusions 541, and the resilient arcuate portions 54 resiliently return to their original orientations. Finally, the gear plate 64 stops when the motor 61 is turned off by the delay control circuitry.

When the gear plate 64 rotates in the clockwise direction R, the driving protrusions 641 abut against the driven protrusions 521 at respective second side faces of the driven protrusions 521. The gear plate 64 actuates the clutch 50 to rotate in the clockwise direction R. Accordingly, the clutch 50 actuates the mating shaft 32 to rotate, the knob 30 is rotated, and the transmission shaft 4 is rotated. The latch of the bolt assembly 3 is actuated to be unlocked. Simultaneously, the sensor arm 55 rotates to contact the sensor switch 74. The motor 61 is actuated by the sensor switch 74 to prepare to turn off. When the transmission shaft 4 reaches a locked position, the clutch 50 has been stopped, but the motor 61 continues to rotate due to the delay control circuitry. Thus the gear plate 64 continues to rotate such that the driving protrusions 641 force the driven protrusions 521 and the resilient arcuate portions 54 to deform inwardly. The driving protrusions 641 ride over the driven protrusions 521, and the resilient arcuate portions 54 resiliently return to their original orientations. Finally, the gear plate 64 stops when the motor 61 is turned off by the delay control circuitry.

A user can operate the lock 1 by hand, without employing the driving unit 60. The user may want to do so if, for example, the driving unit 60 has failed after the latch 3 has been locked. The user directly turns the knob 30, to rotate the transmission shaft 4. Referring to FIG. 5, the user turns the knob 33 in the clockwise direction T to operate the lock 1. As described above in relation to locking of the lock 1, the driving protrusions 641 of the gear plate 64 have already ridden over the driven protrusions 541 of the clutch 50. Therefore, the clutch 50 is free to move in direction T. Accordingly, the knob 30 can freely rotate in direction T. The motor 61 cannot be “back driven” by the user turning the knob 30 in direction T.

It is understood that the invention may be embodied in other forms without departing from the spirit thereof. Thus, the present example and embodiment is to be considered in all respects as illustrative and not restrictive, and the invention is not to be limited to the details given herein.

1. An electronically-driven lock comprising:
A bolt assembly having a latch;
A transmission shaft extending through the bolt assembly and controlling the latch of the bolt assembly;
an inner lock unit actuating the transmission shaft and comprising a base, a cover covering the base, a knob, a driving unit, and a clutch, the knob comprising a mating shaft receiving the transmission shaft therein, the driving unit comprising a gear plate having a pair of driving protrusions; the clutch comprising a pair of driven protrusions and a mating slot, the clutch being rotatably received in the gear plate, the mating shaft extending through and mating with the clutch in the mating slot;
wherein when the driven protrusions of the clutch are actuated by the driving protrusions of the gear plate, the gear plate rotates the clutch, and the clutch actuates the knob to rotate the transmission shaft, thereby moving the latch between a locked position and an unlocked position.

2. The electronically-driven lock as described in claim 1, wherein a central sleeve extends upwardly from a base of the clutch, the mating slot is defined in the central sleeve and is generally rectangular, and the mating shaft of the knob has a generally rectangular cross-section.

3. The electronically-driven lock as described in claim 2, wherein a pair of posts extends upwardly from the base on opposite sides of the central sleeve respectively.

4. The electronically-driven lock as described in claim 2, wherein a pair of arcuate slits is defined in opposite sides of the base of the clutch thereby forming a pair of resilient arcuate portions, and the driven protrusions are outwardly formed from the resilient arcuate portions.

5. The electronically-driven lock as described in claim 2, wherein a sensor arm extends radially outwardly from the central sleeve.

6. The electronically-driven lock as described in claim 1, wherein the knob comprises a head, and the mating shaft integrally extends from the head.

7. The electronically-driven lock as described in claim 1, wherein the gear plate comprises a gear portion around an outer circumference thereof.

8. The electronically-driven lock as described in claim 7, wherein the driving protrusions of the gear plate are inwardly formed from respective opposite sides of an inner periphery of a circumferential wall of the gear plate.

9. The electronically-driven lock as described in claim 7, wherein the driving unit further comprises a motor, a worm connecting with the motor, and a gear set connecting with the worm.

10. The electronically-driven lock as described in claim 9, wherein the gear set comprises an upper gear meshing with the gear portion of the gear plate, a lower gear integrally formed with the upper gear and meshing with the worm, a C-shaped gasket, and a gear shaft extending through the lower gear, the upper gear and the C-shaped gasket.

11. The electronically-driven lock as described in claim 3, wherein the lock unit further comprises a cap plate covering the clutch, a through hole is defined in the cap plate, and a pair of hollow cylindrical seats is formed on the cap plate on opposite sides of the through hole for engaging with the posts of the clutch.

12. The electronically-driven lock as described in claim 1, wherein a supporting bracket is arranged on the base of the lock unit, a sleeve is arranged on the supporting table, and the gear plate surrounds the sleeve of the supporting bracket and supports the clutch.

13. The electronically-driven lock as described in claim 12, wherein a positioning block, a clip spring, a gasket and a bottom cover are sequentially disposed around the mating shaft of the knob, and the mating shaft extends through the cap plate, the clutch, the gear plate and the sleeve of the supporting bracket.

14. The electronically-driven lock as described in claim 5, wherein a pair of sensor switches is received in a pair of switch holders arranged on the base, and the sensor arm can movably contact each of the sensor switches for detecting the locked or unlocked position of the latch.

15. The electronically-driven lock as described in claim 1, wherein the motor is received in a motor housing arranged on the base, and a resilient clip is formed on the base at the motor housing for facilitating retention of the motor.

16. The electronically-driven lock as described in claim 1, wherein a pair of connector bracket assemblies is arranged on the base for receiving a pair of connectors therein respectively.

17. The electronically-driven lock as described in claim 1, wherein a detector housing is arranged on the base for receiving a shock detector therein.

18. An electronically-driven lock comprising:
a bolt assembly having a latch adapted to be mounted in a door;
a transmission shaft extending through the bolt assembly and controlling the latch of the bolt assembly;
an inner lock unit and an outer lock unit adapted to be attached to opposite sides of the door; wherein
the inner lock unit comprises a base, a driving unit, a clutch, a knob, and a cover covering the base; the knob comprises a mating shaft receiving the transmission shaft therein; the driving unit comprising a motor, a worm, a gear set and a gear plate; the gear plate comprising a pair of driving protrusions, and a gear portion around an outer circumference thereof; the clutch comprising a pair of driven protrusions, and a mating slot defined therein, the clutch being rotatably received in the gear plate, the mating shaft fittingly extending through the mating slot;
wherein when the motor transmits power to the gear plate, the driving protrusions of the gear plate actuate the driven protrusions of the clutch such that the gear plate rotates the clutch, the clutch actuates the mating shaft of the knob to rotate and thereby rotate the transmission shaft, thereby actuating the latch between a locked state and an unlocked state.

19. The electronically-driven lock as described in claim 18, wherein the clutch further comprises a base and a central sleeve, and a sensor arm extends radially outwardly from the central sleeve.

20. The electronically-driven lock as described in claim 19, wherein a pair of arcuate slits is defined in opposite sides of the base of the clutch thereby forming a pair of resilient arcuate portions, and the driven protrusions are outwardly formed from the resilient arcuate portions.

21. The electronically-driven lock as described in claim 19, wherein a pair of sensor switches is received in a pair of switch holders arranged on the base, and the sensor arm can movably contact each of the sensor switches for detecting the locked or unlocked state of the latch.

22. The electronically-driven lock as described in claim 18, wherein the gear plate comprises a gear portion around an outer circumference thereof, and the driving protrusions of the gear plate are inwardly formed from respective opposite sides of an inner periphery of a circumferential wall of the gear plate.

23. The electronically-driven lock as described in claim 23, wherein the gear set comprises an upper gear meshing with the gear portion of the gear plate, a lower gear integrally formed with the upper gear and meshing with the worm, a C-shaped gasket, and a gear shaft extending through the lower gear, the upper gear and the C-shaped gasket.

24. An electrically-driven lock equipped with manual operation mechanism, comprising:
a stationary base;
a transmission shaft rotatable relative to the base and extending in a first direction, said transmission shaft being adapted to be rotated to two positions deciding whether a lock bolt is allowed to move along a second direction perpendicular to said first direction;
an inner lock unit actuating the transmission shaft to rotate clockwise or counterclockwise, said inner lock unit including:
a driving unit having a gear plate actuated by a motor, said gear plate defining a driving protrusion thereon; and
a clutch unit having a mating shaft linked to said transmission shaft, said clutch unit defining a driven protrusion engaged with said driving protrusion; wherein
said driving unit and said clutch unit are concentrically rotated relative to the base.

25. The lock as described in claim 24, wherein said driving unit and said clutch unit are essentially synchronically rotated, either clockwise or counterclockwise, with each other, when the driving unit is actuated to rotate by the motor and urges the clutch unit to rotate too, while only the clutch unit is rotated during manual operation.

26. The lock as described in claim 24, wherein said at least one of said driving unit and said clutch unit own resiliency, so as to allow said driving protrusion to be mutually exclusively located on respectively opposite sides of said driven protrusion, when said driving unit is actuated to rotate by the motor either clockwise or counterclockwise.

27. The lock as described in claim 24, wherein said gear plate defines outer gears adapted to be directly or indirectly actuated by the motor.
